(19) United States
(12) Patent Application Publication
(10) Pub. No.: US 2009/0089972 A1
(43) Pub. Date: Apr. 9, 2009

(54) Flexible grip and method of making same

(75) Inventors: David Keith Gill, Pinehurst, NC (US); William W. Andersen, Hope Mills, NC (US)

Correspondence Address: Fay Sharpe LLP, 1228 Euclid Avenue, 5th Floor, The Halle Building, Cleveland, OH, 44115, US

(73) Assignee: Eaton Corporation

(21) Appl. No.: 11/906,784

(22) Filed: Oct. 3, 2007

(51) Int. Cl. B25G 1/00; B29C 39/00

(52) U.S. Cl. 16/110.1; 264/299

(57) ABSTRACT

A flexible grip for an implement handle and method of making same in which the grip is molded with a core or mandrel having a spiral groove which forms a thread like surface on the interior of the grip when molded. Upon removal from the mold, the core may be easily removed by relative rotation of the core and grip one with respect to the other.

### BACKGROUND

The present disclosure relates to flexible or “soft” grips for implements such as those having a handle for manual operation. In particular, the disclosure relates to flexible grips for implements such as sporting goods, for example, tennis rackets, golf clubs and flexible grips for other manual implements with handles such as hammers, axes, garden tools, shovels, and the like. Flexible grips for such implements have been molded of elastomeric or rubber material and then assembled over the grip end of the handle and retained thereon by frictional engagement with the handle. In the design and manufacture of such grips, it has been desired to provide flexibility or softness to the grip beyond the mechanical indentation surface hardness properties of the rubber or elastomeric material. In addressing this need, the interior of the grip has been molded with radial grooves to provide air pockets or voids and localized reduced wall thickness to increase the deflection of the grip under manual pressure to provide a more resilient or soft feeling to the grip for facilitating the user's ability to maintain contact with the implement during movement.

Heretofore, the core or mandrel employed in the mold for forming the grip for an implement handle has been provided with a multiplicity of annular ribs spaced along the mandrel which formed the circumferentially extending grooves on the interior of the grip wall for providing the air pockets or voids.

However, in molding grips of the aforesaid type, it has been found difficult to provide a core for forming the interior grooves of sufficient radial extension and yet permit ready removal of the molded grip from the core upon removal of the grip from the mold. Heretofore, compressed air has been introduced between the grip and the core to expand the grip and permit ready removal of the molded grip from the core. However, when the core is configured to provide the desired depth of grooves on the interior of the grip, it has been found virtually impossible to remove the grip from the core by the usual technique of introducing compressed air between the grip and the core as the material of the grip cannot expand sufficiently to permit core removal without rupturing.

Thus, it has been desired to provide a way or means of locally reducing the thickness of a molded grip for an implement to provide the desired flexibility or softness and, to do so in a manner that enables ready removal of the core from the molded grip upon removal from the mold.

### BRIEF DESCRIPTION

The present disclosure describes and illustrates a unique flexible molded grip for an implement handle which has voids or spaces provided on the interior of the grip such that upon assembly of the grip onto the implement handle, additional resiliency or softness of the grip is enabled by virtue of the localized reduction in the wall thickness of the grip about the handle. The voids or air pockets within the grip are formed by a mandrel or core having a spiral groove formed thereon which provides threadlike surfaces on the mandrel for forming the grooves on the grip. Upon removal of the molded grip and the mandrel from the grip forming mold, the grip is separated from the mandrel by rotating one of the mandrel and grip with respect to the other to provide ready separation thereof. The rotating removal of the grip from the mandrel thus eliminates the need for injecting pressurized air to expand the grip to facilitate removal from the mandrel.

### BRIEF DESCRIPTION OF THE DRAWINGS

FIG. 1 is a view of the grip of the present disclosure assembled onto an exemplary implement handle such as the shaft of a golf club;

FIG. 2 is a view of a portion of the core or mandrel employed in molding the grip.

FIG. 3 is a section view of a mold with the grip molded therein; and,

FIG. 4 is a section view of the molded grip after removal of the mandrel or core.

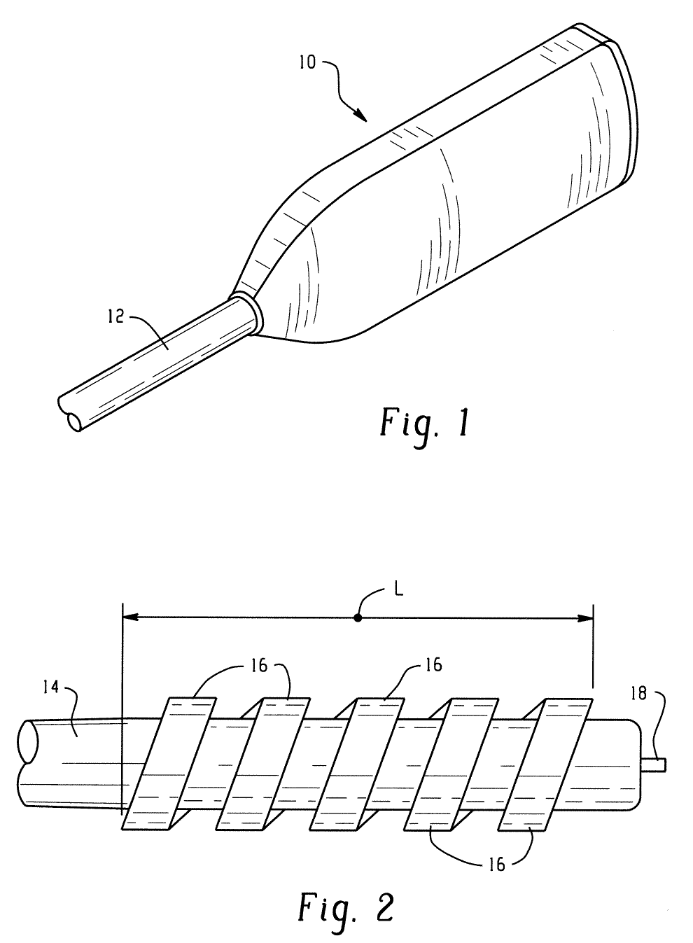

### DETAILED DESCRIPTION

Referring to the drawings, a molded flexible grip for an implement handle is indicated generally at 10 as assembled onto the end of an implement handle 12 which may be any of the aforesaid described types of implements.

The grip 10 is formed by molding of suitable flexible material such as rubber or elastomeric material suitable for providing the desired flexibility for the grip. In the present practice, it has been found satisfactory to mold the grip of material having a durometer hardness of about 30-70 measured on the shore “A” scale in the cured state; however, other materials with differing surface hardness properties may be employed if desired.

Referring FIG. 2, a core or mandrel 14 formed of rigid material has a spiral groove formed there along for a distance denoted by the reference character L in FIG. 2 such that the spiral groove forms threads 16 on the mandrel. In addition, the mandrel has a reduced diameter projection 18 provided on the end thereof which serves to form a vent hole in the grip upon insertion of the mandrel or core in the mold. In the present practice, it has been found satisfactory to form the thread 16 of the square profile or shape commonly referred to as an ACME thread.

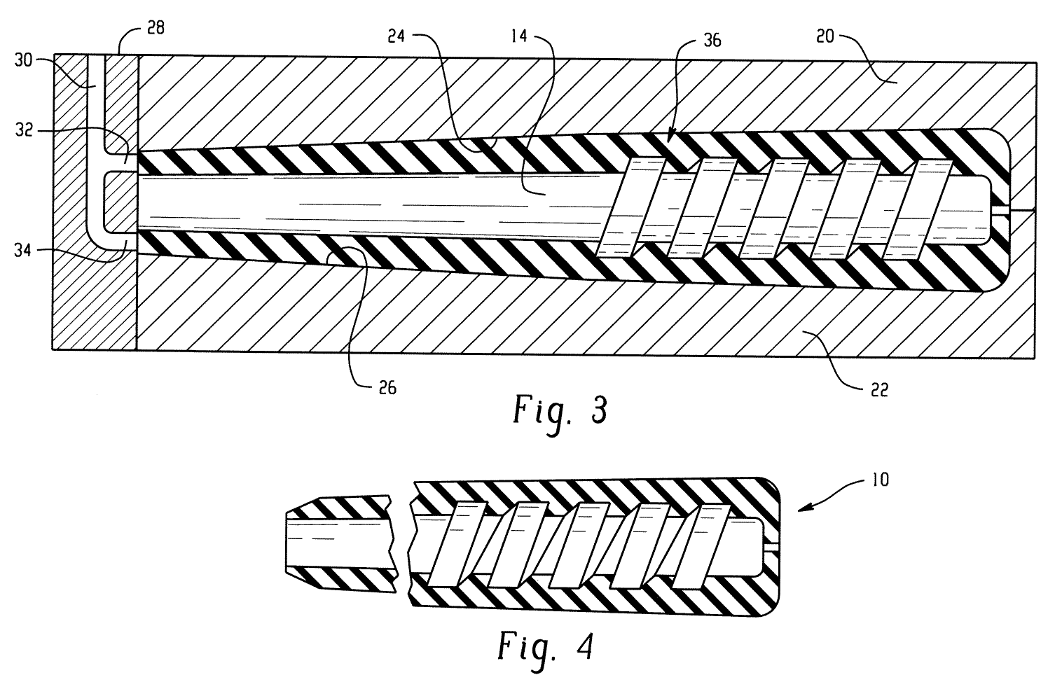

Referring to FIG. 3, a pair of mating mold halves or sections 20, 22 is provided, each with a mold recess 24, 26, respectively, formed therein configured for forming the exterior shape of the grip 10; and, the mold sections are shown in the closed condition in FIG. 3.

The mandrel 14 is inserted in the cavity formed by the mold recesses 24, 26; and, a cap or closure 30 is disposed over the open end of the mold cavity formed by recesses 24, 26, which cap has molding sprues 30, 32, 34 formed therein, with the sprues 32, 34 communicating with the mold recesses 24, 26. Although the exemplary mold sprues 32, 34 are shown as formed in the mold closure 30, it will be understood that, alternatively they may be formed in the mold sections 20, 22 if desired. The elastomeric or rubber material for forming the grip is then introduced through the sprues 30, 32, 34 into the mold cavity, as denoted by reference numeral 36, and forms the shape of the grip to be molded and can be accomplished by known techniques such as, for example, injection or transfer molding. Alternatively, precut strips of elastomeric material may be placed in the mold cavities 24, 26 prior to closing the mold over the mandrel 14.

In the present practice, it has been found satisfactory to form the mandrel with a diameter in the range of about 5-25 mm; however, other sizes may be utilized, depending upon the desired size and configuration of the grip to be molded.

Referring to FIG. 4, the completed molded grip is shown with the mandrel 14 removed which is accomplished by rotating one of the mandrel and grip with respect to the other and thereby unscrewing the mandrel from the grip along the threaded engagement surfaces thereof. This rotary removal may be accomplished.

The present disclosure thus describes a uniquely configured flexible grip for an implement handle which has a plurality of voids or air pockets therein formed in a spiral configuration by a core or mandrel inserted in the mold with a threaded surface on the mandrel. Upon completion of the molding, the mandrel and grip are separated by relative rotation therebetween.

The exemplary embodiment has been described with reference to the drawings. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A method of making a flexible grip for assembly onto an implement handle comprising:
(a) disposing flexible moldable material in sections of a mold;
(b) providing a mandrel and forming a spiral groove thereon;
(c) disposing the mandrel in the moldable material and closing the mold sections;
(d) curing the moldable material in the mold and removing the mold sections; and,
(e) rotating one of the cured moldable material and mandrel with respect to the other and removing the mandrel.

2. The method defined in claim 1, wherein the step of forming a spiral groove includes forming a generally square profile thread thereon.

3. The method defined in claim 2, wherein the step of forming a square profile thread includes forming a thread with an acme thread configuration.

4. The method defined in claim 1, wherein the step of providing a mandrel includes providing a mandrel having a diameter in the range of about 5-25 mm.

5. The method defined in claim 1, wherein the step of disposing moldable material includes disposing material having a durometer upon curing of about 30-70 measured on the Shore “A” scale.

6. The method defined in claim 1, wherein the step of curing includes heating.

7. A method of making a flexible grip for assembly onto an implement handle comprising:
(a) providing a mold with a cavity for configuring the grip;
(b) forming a spiral groove on a mandrel and inserting the mandrel into the cavity;
(c) injecting moldable flexible material into the mold cavity;
(d) curing the moldable material in the mold;
(e) removing the mandrel and cured grip material from the mold; and,
(f) rotating one of the cured grip material and mandrel with respect to the other and removing the mandrel from the grip.

8. The method defined in claim 7, wherein the step of forming a spiral groove includes forming a generally square profile thread thereon.

9. The method defined in claim 7, wherein the step of injecting moldable flexible material includes injecting material having a durometer upon curing of about 30-70 measured on the Shore “A” scale.

10. The method defined in claim 7, wherein the step of forming a spiral groove includes forming a spiral groove on a mandrel having a diameter of about 5-25 mm.

11. The method defined in claim 7, wherein the step of curing includes heating.

12. A flexible grip for an implement handle comprising:
(a) a hollow member formed of flexible material and having an opening in the hollow for receiving the implement handle;
(b) a spiral groove formed in the internal surface of the hollow for forming spiral surfaces for contacting the implement handle upon insertion thereon in the opening.

13. The grip defined in claim 12, wherein the member has a generally tubular configuration with one end thereof substantially closed.

14. The grip defined in claim 12, wherein the flexible material comprises elastomeric material.

15. The grip defined in claim 12, wherein the flexible material comprises moldable material.

16. The grip defined in claim 12, wherein the flexible material has a durometer hardness in the range of about 30-70 as measured on the Shore “A” scale.

17. The grip defined in claim 12, wherein the spiral groove has a diameter in the range of about 5-25 mm.

18. A method of making a flexible grip for assembly onto an implement handle comprising:
(a) forming a cavity in a mold and configuring the wall of the cavity to the desired surface of a grip to be molded;
(b) forming a spiral groove on a mandrel and disposing the mandrel in the mold cavity;
(c) introducing moldable flexible material into the mold cavity;
(d) curing the moldable material in the mold over the mandrel;
(e) removing the mandrel and cured material from the mold cavity; and,
(f) rotating one of the cured grip and mandrel with respect to the other and removing the cured grip from the mandrel.

19. The method defined in claim 18, wherein the step of introducing moldable flexible material includes introducing uncured elastomeric material.

20. The method defined in claim 18, wherein the step of introducing moldable flexible material includes one of compression molding, transfer molding and injection molding.

21. The method defined in claim 18, wherein the step of introducing flexible moldable material includes introducing material having a durometer upon curing in the range of about 30-70 measured on the Shore “A” scale.

22. The method defined in claim 18, wherein the step of forming a spiral groove includes forming a generally square profile thread thereon.

23. The method defined in claim 18, wherein the step of forming a spiral groove includes forming a spiral groove on a mandrel having a diameter in the range of about 5-25 mm.
